(19) United States
(12) Patent Application Publication
(10) Pub. No.: US 2008/0159594 A1
(43) Pub. Date: Jul. 3, 2008

(54) BIRD VIEW VISUAL SYSTEM WITH FISHEYE DISTORTION CALIBRATION AND METHOD THEREOF

(75) Inventors: Chui-Fan Chiu, Taoyuan Hsien (TW); Chun-Chieh Wang, Taoyuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: DELTA ELECTRONICS, INC., Taoyuan Hsien (TW)

(21) Appl. No.: 11/966,222

(22) Filed: Dec. 28, 2007

(30) Foreign Application Priority Data
Jan. 3, 2007 (TW) 096100256

(51) Int. Cl. G06K 9/00; G06K 9/40

(52) U.S. Cl. 382/104; 382/275

(57) ABSTRACT

A bird view visual system for a vehicle having a fisheye distortion calibration is provided. The bird view visual system includes at least one image sensor equipping therewith a wide lens, for monitoring an environment change around the vehicle and generating an image signal in accordance with the environment change, a control circuit having therein an image processing program for receiving and processing the image signal in order to calibrate a fisheye distortion of the image signal and generate a calibrated image signal, and a display receiving and displaying the calibrated image signal.

### FIELD OF THE INVENTION

The present invention relates to a bird view visual system, and more particularly to a bird view visual system having a fisheye distortion calibration.

### BACKGROUND OF THE INVENTION

In recent decades, with the vigorous developments of the optical display technology, it becomes a trend in the automobile industry that more and more vehicles are equipped with the navigation system having the accurate and rapid image retrieving and displaying technology. The navigation system provides the information regarding where the vehicle is located and/or the surrounding environments of the vehicle, and shows such information to the driver and/or the passenger via a monitor. In generally, the navigation system according to the prior art is combined with a global positioning system (GPS), which supplies the real-time location information of the moving vehicle through a satellite signal receiver, so that the GPS combining with a database of map can be used as a satellite navigation system for the vehicle. Besides the navigation system in connection with the GPS, a further innovative navigation system, i.e. the bird view visual system providing the real time information of the surrounding environment of the vehicle, is often equipped on the vehicle. The known bird view visual systems provide the images regarding the surrounding of the vehicle to the driver by one or more image sensor(s) disposed around the vehicle, wherein the image sensor captures the images regarding two meters around the vehicle so that the driver can steer the car in a more precise and safer way in accordance therewith.

Please refer to FIG. 1, which schematically shows a bird view visual system according to the prior art. As shown in FIG. 1, a bird view visual system 100 includes the image sensors 101A-101D, wherein the image sensors 101A-101D are mounted at a front side, a rear side, a right side and a left side of the vehicle for monitoring the environment information around the vehicle.

However, in order to obtain a wider viewable field, the image sensor of the known bird view visual system is usually equipped with a wide lens, i.e. the so called fisheye lens, for providing more information regarding the environmental around the vehicle to the driver. Nevertheless, because most of the wide lenses are the lenses with the relatively higher curvature, the images retrieved therefrom would be unavoidably distorted because of the high curvature. Such distortion result of the retrieved image is also called the fisheye distortion of the image, as comparatively illustrated in FIG. 2A and FIG. 2B. Specifically, FIG. 2A shows a normal and undistorted image retrieved from a normal lens, and FIG. 2B shows an image with the fisheye distortion taken by a wide (fisheye) lens. According to the comparison of FIG. 2A and FIG. 2B, it is known that the central part of the image retrieved from the fisheye lens would be enlarged. Nevertheless, because the pattern of the distortion is a cambered surface from the center of the image to the boundary region of the image, the distortion of the image will be more and more serious from the central part to the boundary region of the image. So, if the driver steers the car in accordance with the distorted images retrieved from the fisheye lens, the erroneous estimate might happen. Therefore, it is necessary to calibrate the image captured by the bird view visual system equipped with the fisheye lens for providing the more accurate information to the driver.

### SUMMARY OF THE INVENTION

In accordance with one aspect of the present invention, a bird view visual system for a vehicle having a fisheye distortion calibration is provided. The system includes at least one image sensor equipping therewith a wide lens, disposed on a vehicle for monitoring an environment change therearound and generating an image signal in accordance with the environment change, a control circuit having therein an image processing program for receiving and processing the image signal in order to calibrate a fisheye distortion of the image signal and generate a calibrated image signal, and a display receiving and displaying the calibrated image signal.

Preferably, the system further includes four image sensors.

Preferably, the four image sensors are respectively mounted at a front side, a rear side, a right side and a left side of the vehicle.

Preferably, the at least one image sensor further includes an adjustable apparatus adjusting a viewing angle of the image sensor.

Preferably, the wide lens is a fisheye lens.

Preferably, the image processing program calculates an algorithmic parameter obtained from a parameter of the fisheye lens.

Preferably, the control circuit having the image processing program generates the calibrated image signal through a reverse compensation for the fisheye distortion of the image signal.

In accordance with another aspect of the present invention, a preferable bird view visual system for a vehicle having a fisheye distortion calibration is provided. The system includes at least one image sensor disposed on a vehicle for monitoring an environment change around the vehicle and generating an image signal in accordance with the environment change, a control circuit having therein an image processing program for receiving and processing the image signal in order to calibrate the fisheye distortion of the image signal and generate a calibrated image signal, and a display receiving and displaying the calibrated image signal.

Preferably, the system further includes four image sensors.

Preferably, the four image sensors are respectively mounted at a front side, a rear side, a right side and a left side of the vehicle.

Preferably, the at least one image sensor is equipped with a fisheye lens for enlarging a viewing range of the image sensor.

Preferably, the image processing program calculates an algorithmic parameter obtained from a parameter of the fisheye lens.

In accordance with another aspect of the present invention, a fisheye distortion calibration method of a bird view visual system for a vehicle is provided. The method includes the following steps of: a) providing at least one image sensor mounted on a vehicle for generating a image signal outside the vehicle; b) calibrating a fisheye distortion of the image signal through a image processing program in order to generate a calibrated image signal; and c) displaying the calibrated image signal.

Preferably, the method further includes a step of providing four image sensors respectively mounted at a front side, a rear side, a right side and a left side of the vehicle for monitoring an environment change around the vehicle.

Preferably, the image processing program is integrated into a control circuit.

Preferably, the image processing program calculates an algorithmic parameter obtained from a parameter of the fisheye lens.

Preferably, the calibrated image signal is generated by the image processing program through a reverse compensation for the fisheye distortion of the image signal.

### BRIEF DESCRIPTION OF THE DRAWINGS

FIG. 1 is a schematic diagram showing a known bird view visual system according to the prior art.

FIG. 2A shows an image taken by a normal lens, and FIG. 2B shows an image with the fisheye distortion taken by a fisheye lens.

FIG. 3A schematically shows the distortion effect of the fisheye distortion image captured from a known bird view visual system for a vehicle.

FIG. 3B schematically shows the compensation result of the fisheye distortion image according to the FIG. 3A.

FIG. 4 schematically shows the configuration and operation of the bird view visual system having a fisheye distortion calibration according to the present invention.

FIG. 5A shows an image with the fisheye distortion, and FIG. 5B shows a calibrated image after being implemented the calibration method of the present invention.

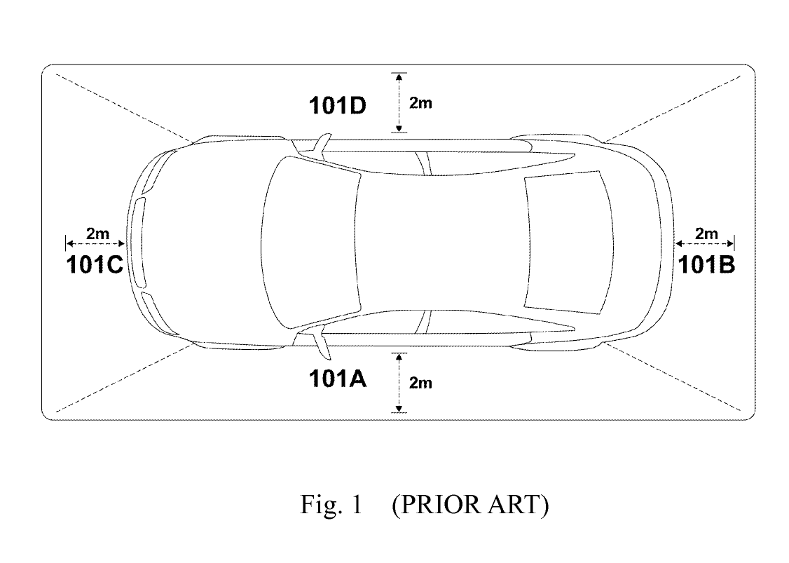

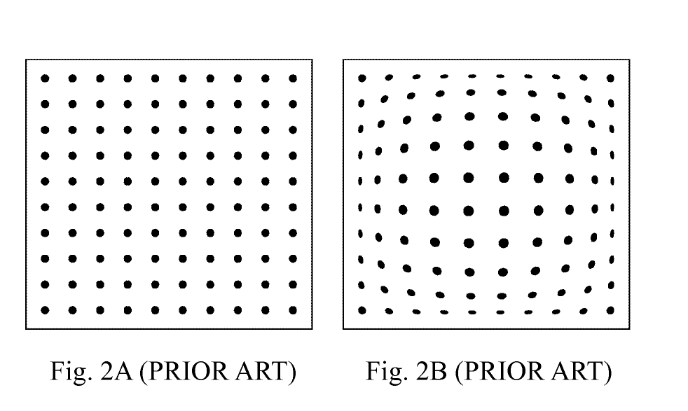

### DETAILED DESCRIPTION OF THE PREFERRED EMBODIMENT

In order to further illustrate the techniques, methods and efficiencies used to procure the aims of this invention, please see the following detailed descriptions. It is believable that the features and characteristics of this invention can be deeply and specifically understood by the descriptions. It is to be noted that the following descriptions of preferred embodiments of this invention are presented herein for the purposes of illustration and description only; it is not intended to be exhaustive or to be limited to the precise form disclosed.

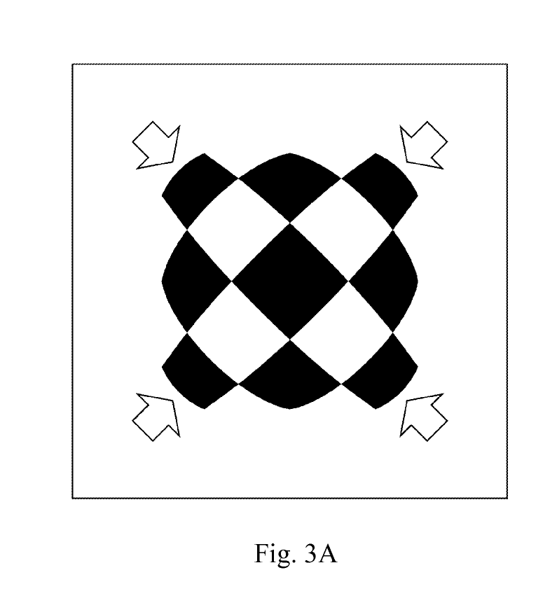

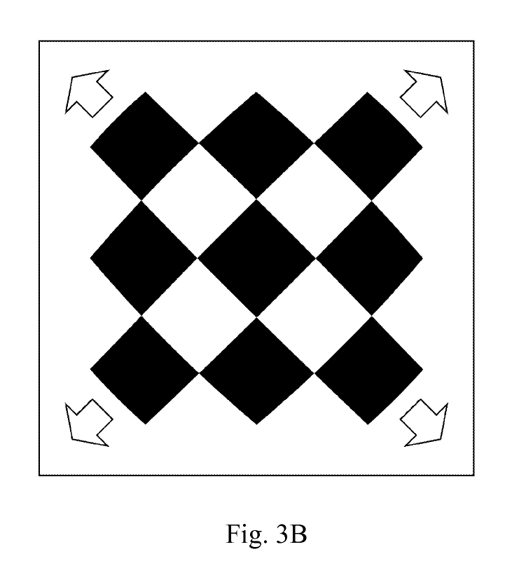

Please refer to FIG. 3A) which shows an image captured by a known bird view visual system, wherein the captured image has a fisheye distortion effect existing therein. As shown in FIG. 3A, it seems that there exists a compression effect from the surrounding region to the center region of the fisheye distortion image, and such compression effect become more and more serious as the distance is more far away from the central part of the image. Based on such compression effect of the fisheye distortion, the present invention provides a calibration method for suppressing the compression effect of the fisheye distortion. Please refer to the FIG. 3B, which schematically shows the key process of the method of the present invention for calibrating the fisheye distortion of the image. As shown in FIG. 3B, the method of the present invention includes an important image calibration process i.e. making the image be stretched out over the direction opposite to the compression direction of the distortion image, so that the compression effect of the distortion image is mitigated and the distortion parts of the image can be calibrated. As can be seen from the FIG. 3B, after calibrating fisheye distortion of the image by the compensation of opposite stretching, the distortion parts of the image are clearly calibrated.

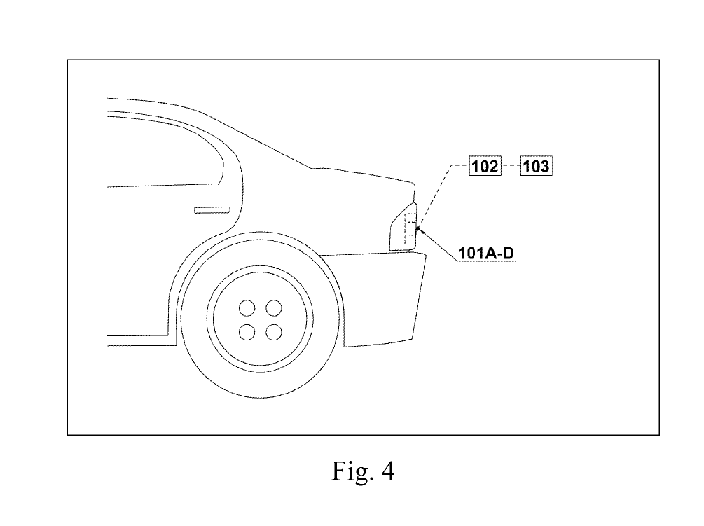

Please refer to FIG. 4, which schematically shows a configuration and process of a bird view visual system having a fisheye distortion calibration according to a preferred embodiment of the present invention. It should be noticed that the configuration and/or the arrangement of the bird view visual system 200 of the present invention are almost the same as the known bird view visual system, i.e the bird view visual system of the present invention may comprises four image sensors 101A-101D respectively mounted at a front side, a rear side, a right side and a left side of the vehicle. Furthermore, as shown in FIG. 4, the signals detected by the respective image sensors 101A-101D are calibrated through a control circuit 102, and then transmitted to a display 103, by which the driver can get the calibrated image signal.

Specifically, during the image calibration process of control circuit 102, the image signals detected by the image sensors 101A-101D would be calculated by an algorithmic parameter of an image processing program, in order to calibrate the fisheye distortion of the detected image. In a preferred embodiment of the present invention, the image processing program can be stored in a storage device of the control circuit 102, such as, a memory included therein. As mentioned above, the image processing program calibrates the fisheye distortion through generating a reverse compensation to the compressed image, wherein the direction of the reverse compensation is opposite to the central point of the image. However, it should be noted that the algorithmic parameter of the image processing program is determined by a parameter of the wide (fisheye) lens arranged on the image sensor. Accordingly, the algorithmic parameter of the image processing program would be changed in accordance with the various wide lenses arranged.

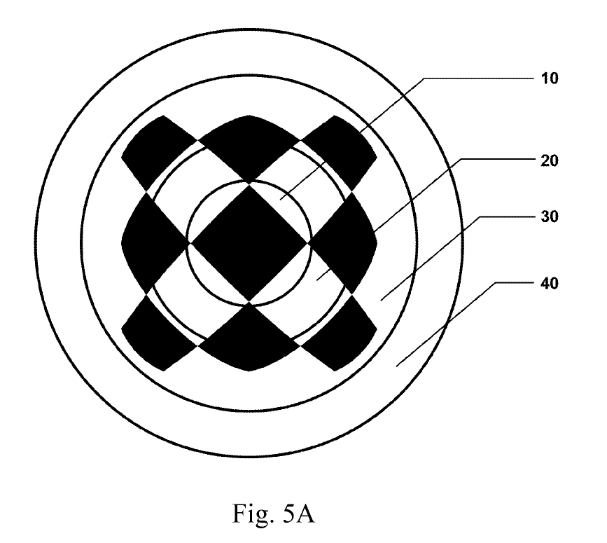

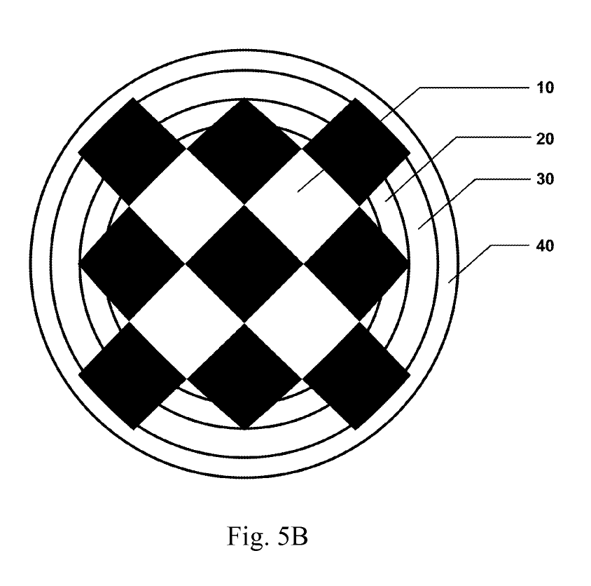

Please refer to FIGS. 5A and 5B, which comparatively show a fisheye distortion image and a calibrated image after being implemented by the calibration method of the present invention. From the comparison of FIG. 5(A) and FIG. 5(B), the calibration result of the fisheye distortion image through the calibration method of the present invention is specifically illustrated. As shown in FIG. 5A, which shows a distortion image captured by a fisheye lens, the distortion image can be divided into several concentric circle regions in accordance with the distortion level thereof, wherein the concentric circle region 10, i.e. the region near to the central part of the image, is nearly non-distorted. However, regarding the regions further from the central part of the image, i.e. from the concentric circle region 20 to the concentric circle region 40, the distortion level become more and more obvious and serious. While in comparison with the FIG. 5B, which shows a calibrated image where the fisheye distortion thereof is much calibrated by the fisheye distortion calibration method of the present invention. As shown in FIG. 5B, the non-distorted region or the region which is just slightly distorted, as denoted by the concentric circle region 10, is remarkably increased in comparison with FIG. 5A, and the regions with more serious distortion, i.e. the regions denoted by the concentric circle regions 20, 30 and 40, are shrunk to the edges of the image. Accordingly, most regions of the calibrated image are remained as non-distorted or just slightly distorted, as shown in FIG. 5B. Moreover, because the regions having serious distortion as denoted by the concentric circle regions 30 and 40 are remarkably shrunk to utmost edges of the image, the image affected by the fisheye distortion would be neglected.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. A bird view visual system for a vehicle having a fisheye distortion calibration, comprising:
at least one image sensor equipping therewith a wide lens, disposed on a vehicle for monitoring an environment change around the vehicle and generating an image signal in accordance with the environment change;
a control circuit having therein an image processing program for receiving and processing the image signal in order to calibrate a fisheye distortion of the image signal and generate a calibrated image signal; and
a display receiving and displaying the calibrated image signal.

2. A system according to claim 1 further comprising four image sensors.

3. A system according to claim 2, wherein the four image sensors are respectively mounted at a front side, a rear side, a right side and a left side of the vehicle.

4. A system according to claim 1, wherein the wide lens is a fisheye lens.

5. A system according to claim 4, wherein the image processing program calculates an algorithmic parameter obtained from a parameter of the fisheye lens.

6. A system according to claim 1, wherein the control circuit having the image processing program generates the calibrated image signal through a reverse compensation for the fisheye distortion of the image signal.

7. A bird view visual system for a vehicle having a fisheye distortion calibration, comprising:
at least one image sensor disposed on a vehicle for monitoring an environment change around the vehicle and generating an image signal in accordance with the environment change;
a control circuit having therein an image processing program for receiving and processing the image signal in order to calibrate the fisheye distortion of the image signal and generate a calibrated image signal; and
a display receiving and displaying the calibrated image signal.

8. A system according to claim 7 further comprising four image sensors.

9. A system according to claim 8, wherein the four image sensors are respectively mounted at a front side, a rear side, a right side and a left side of the vehicle.

10. A system according to claim 7, wherein the at least one image sensor is equipped with a fisheye lens for enlarging a viewing range thereof.

11. A system according to claim 10, wherein the image processing program calculates an algorithmic parameter obtained from a parameter of the fisheye lens.

12. A fisheye distortion calibration method of a bird view visual system for a vehicle, comprising:
(a) providing at least one image sensor mounted on a vehicle for generating a image signal outside the vehicle;
(b) calibrating a fisheye distortion of the image signal through a image processing program in order to generate a calibrated image signal; and
(c) displaying the calibrated image signal.

13. A method according to claim 12 further comprising a step of providing four image sensors respectively mounted at a front side, a rear side, a right side and a left side of the vehicle for monitoring an environment change around the vehicle.

14. A method according to claim 12, wherein the image processing program is integrated into a control circuit.

15. A method according to claim 12, wherein the at least one image sensor is equipped with a fisheye lens for enlarging the image range thereof.

16. A method according to claim 15, wherein the image processing program calculates an algorithmic parameter obtained from a parameter of the fisheye lens.

17. A method according to claim 12, wherein the calibrated image signal is generated by the image processing program through a reverse compensation for the fisheye distortion of the image signal.
